(19) United States
(12) Patent Application Publication
(10) Pub. No.: US 2025/0300589 A1
(43) Pub. Date: Sep. 25, 2025

(54) GROUND MOUNT FOR SOLAR MODULES

(71) Applicant: Richard Post, Eugene, OR (US)

(72) Inventor: Richard Post, Eugene, OR (US)

(73) Assignee: Richard Post, Eugene, OR (US)

(21) Appl. No.: 19/088,860

(22) Filed: Mar. 24, 2025

Related U.S. Application Data
(60) Provisional application No. 63/569,454, filed on Mar. 25, 2024.

(51) Int. Cl. H02S 20/10; H02S 40/10

(52) U.S. Cl. CPC H02S 20/10; H02S 40/10

(57) ABSTRACT

A mounting system for solar modules includes a first plurality of purlins each comprising an upward facing opening providing access to a longitudinal channel of the purlin, a first row of solar panels extending along a first side of the longitudinal channel, and a second row of solar panels extending along a second side of the longitudinal channel. The first row of solar panels is spaced apart from the second row of solar panels by a gap located at the upward facing opening so as to accommodate a track or wheel of a solar module cleaning machine to be received therebetween. A tread layer can be disposed in the longitudinal channel(s) to provide a gripping surface (e.g., traction) for the track or wheel of the cleaning machine.

### CROSS REFERENCE TO RELATED APPLICATIONS

This application claims priority to, and the benefit of, U.S. Provisional Patent Application Ser. No. 63/569,454, entitled “GROUND MOUNT FOR SOLAR MODULES,” filed on Mar. 25, 2024. The '454 Application is hereby incorporated by reference in its entirety for all purposes.

### FIELD

The present disclosure relates generally to photovoltaic equipment, and more particularly to a solar panel mounting structure.

### BACKGROUND

A photovoltaic solar panel is a device that converts solar radiation into electrical energy. It is also called a photovoltaic panel or a solar panel. The main working principle of a photovoltaic solar panel is based on the photovoltaic effect, which means that when light shines on the surface of certain materials, photons in the material can excite electrons, thereby generating electric current. Photovoltaic panels are typically made up of multiple solar cells that use semiconductor materials to achieve the photovoltaic effect.

The power generation efficiency and service life of photovoltaic arrays are greatly affected by dirt and debris, so it is desirable to clean the photovoltaic arrays regularly or as needed. In order to facilitate the cleaning of photovoltaic arrays, the industry has developed cleaning equipment such as photovoltaic cleaning robots.

Solar modules have become more prevalent over the years. Thus, there is a desire for robust mounting systems to accommodate the solar modules.

### SUMMARY

Various aspects of the subject matter described in this disclosure may be embodied in a mounting system for solar modules. The mounting system can include a plurality of upright columns, a first plurality of purlins supported by the plurality of upright columns, each purlin of the first plurality of purlins comprises an upward facing opening providing access to a longitudinal channel, and a second plurality of purlins extending over and perpendicular to the first plurality of purlins.

The mounting system can further include a tread layer disposed in each longitudinal channel of the first plurality of purlins.

In various aspects, each longitudinal channel is configured to receive a wheel or track of a cleaning machine. The tread layer can provide a surface along which the wheel or track of the cleaning machine is configured to travel.

The mounting system can further include a plurality of solar modules coupled to and supported by the second plurality of purlins.

In various aspects, the plurality of solar modules includes a first row of solar modules coupled along a first row of the second plurality of purlins and a second row of solar modules coupled along a second row of the second plurality of purlins, the first row of solar modules is spaced apart from the second row of solar modules by a gap. A first purlin of the first plurality of purlins can be disposed between the first row of solar modules and the second row of solar modules, the first purlin comprises a first upward facing opening exposing a first longitudinal channel that is accessible via the gap. The gap can be at least five inches.

In various aspects, the first row of solar modules includes a first solar module extending between and to the first purlin of the second plurality of purlins and a second purlin of the second plurality of purlins and a second solar module extending between and to the second purlin of the second plurality of purlins and a third purlin of the second plurality of purlins.

The mounting system can further include a plurality of I-beam support members supported by the plurality of upright columns, wherein the first plurality of purlins extend over and across the plurality of I-beam support members.

In various aspects, each purlin of the first plurality of purlins is a large purlin and each purlin of the second plurality of purlins is a small purlin.

Various aspects of the subject matter described in this disclosure may be embodied in a mounting system for solar modules. The mounting system can include a first large purlin extending lengthwise along a first direction, the first large purlin comprises a first upward facing opening exposing a first longitudinal channel, the first longitudinal channel is configured to receive a first wheel or track of a cleaning machine. The mounting system can include a second large purlin extending lengthwise along the first direction, parallel to the first large purlin, the second large purlin comprises a second upward facing opening exposing a second longitudinal channel, the second longitudinal channel is configured to receive a second wheel or track of the cleaning machine. The mounting system can include a third large purlin extending lengthwise along the first direction, parallel to the first large purlin, the third large purlin comprises a third upward facing opening exposing a third longitudinal channel. The mounting system can include a first small purlin extending lengthwise along a second direction perpendicular to the first direction, the first small purlin coupled between and to the first large purlin and the second large purlin. The mounting system can include a second small purlin extending lengthwise along the second direction perpendicular to the first direction, the second small purlin coupled between and to the first large purlin and the second large purlin. The mounting system can include a third small purlin extending lengthwise along the second direction perpendicular to the first direction, the third small purlin coupled between and to the first large purlin and the second large purlin. The mounting system can include a first solar module extending between and to the first small purlin and the second small purlin. The mounting system can include a second solar module extending between and to the second small purlin and the third small purlin.

In various aspects, the mounting system can further include a fourth small purlin extending lengthwise along the second direction perpendicular to the first direction, the fourth small purlin coupled between and to the second large purlin and the third large purlin, a fifth small purlin extending lengthwise along the second direction perpendicular to the first direction, the fifth small purlin coupled between and to the second large purlin and the third large purlin, a sixth small purlin extending lengthwise along the second direction perpendicular to the first direction, the sixth small purlin coupled between and to the second large purlin and the third large purlin, a third solar module extending between and to the fourth small purlin and the fifth small purlin, and a fourth solar module extending between and to the fifth small purlin and the sixth small purlin. The first solar module and the second solar module can be on a first side of the second large purlin and the third solar module and the fourth solar module can be on a second side of the second large purlin, opposite the first side. The first solar module and the second solar module can be separated from the third solar module and the fourth solar module by a gap located at the second upward facing opening of the second large purlin.

The mounting system can further include a tread layer disposed in at least one of the first longitudinal channel, the second longitudinal channel, or the third longitudinal channel. The tread layer can comprise a textured epoxy resin.

The mounting system can further include a plurality of upright columns. The mounting system can further include a plurality of I-beam support members supported by the plurality of upright columns, wherein the first large purlin, the second large purlin, and the third large purlin extend over and across the plurality of I-beam support members.

The first large purlin, the second large purlin, and/or the third large purlin can comprise a stopping member coupled to an end of the at least one of the first large purlin, the second large purlin, or the third large purlin.

The first large purlin, the second large purlin, and/or the third large purlin can each comprise a safety cable system extending along a length thereof. The first large purlin, the second large purlin, and/or the third large purlin can each comprise a first aperture and a second aperture and the safety cable system can be coupled thereto via the first aperture and the second aperture.

Various aspects of the subject matter described in this disclosure may be embodied in a method for manufacturing a mounting system for solar modules. The method can include disposing a first large purlin to extend lengthwise along a first direction, the first large purlin comprises a first upward facing opening exposing a first longitudinal channel, the first longitudinal channel is configured to receive a first wheel or track of a cleaning machine. The method can include disposing a second large purlin to extend lengthwise along the first direction, parallel to the first large purlin, the second large purlin comprises a second upward facing opening exposing a second longitudinal channel, the second longitudinal channel is configured to receive a second wheel or track of the cleaning machine. The method can include disposing a third large purlin to extend lengthwise along the first direction, parallel to the first large purlin, the third large purlin comprises a third upward facing opening exposing a third longitudinal channel. The method can include disposing a first small purlin to extend lengthwise along a second direction perpendicular to the first direction, the first small purlin coupled between and to the first large purlin and the second large purlin. The method can include disposing a second small purlin to extend lengthwise along the second direction perpendicular to the first direction, the second small purlin coupled between and to the first large purlin and the second large purlin. The method can include disposing a third small purlin to extend lengthwise along the second direction perpendicular to the first direction, the third small purlin coupled between and to the first large purlin and the second large purlin. The method can include disposing a first solar module to extend between and to the first small purlin and the second small purlin. The method can include disposing a second solar module to extend between and to the second small purlin and the third small purlin.

In various aspects, the method can further include disposing a fourth small purlin to extend lengthwise along the second direction perpendicular to the first direction, the fourth small purlin coupled between and to the second large purlin and the third large purlin, disposing a fifth small purlin to extend lengthwise along the second direction perpendicular to the first direction, the fifth small purlin coupled between and to the second large purlin and the third large purlin, disposing a sixth small purlin to extend lengthwise along the second direction perpendicular to the first direction, the sixth small purlin coupled between and to the second large purlin and the third large purlin, disposing a third solar module to extend between and to the fourth small purlin and the fifth small purlin, and disposing a fourth solar module to extend between and to the fifth small purlin and the sixth small purlin. The first solar module and the second solar module can be on a first side of the second large purlin and the third solar module and the fourth solar module can be on a second side of the second large purlin, opposite the first side. The first solar module and the second solar module can be separated from the third solar module and the fourth solar module by a gap located at the second upward facing opening of the second large purlin.

The method can further comprise disposing a tread layer in at least one of the first longitudinal channel, the second longitudinal channel, or the third longitudinal channel.

The method can further comprise disposing a solar module cleaning machine to straddle the first solar module with the first wheel or track of the solar module cleaning machine extending into the first longitudinal channel and the second wheel or track of the solar module cleaning machine extending into the second longitudinal channel, and the first wheel or track of the solar module cleaning machine is supported by the tread layer.

The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale and may be exaggerated to better illustrate the important features of the present invention.

FIG. 1A illustrates a ground mounting system for solar modules, according to various aspects.

FIG. 1B illustrates an enlarged view of the ground mounting system for solar modules of FIG. 1A, according to various aspects.

FIG. 1C illustrates the enlarged view of the ground mounting system of FIG. 1B with a solar module cleaning machine installed in a straddling manner over a solar module with the tracks/wheels of the cleaning machine in the longitudinal channels of the large purlins, according to various aspects.

FIG. 2 illustrates an example C-purlin, according to various aspects.

FIG. 3A, FIG. 3B, and FIG. 3C illustrate example large purlins with a tread layer disposed on a bottom interior surface of the longitudinal channel, according to various aspects.

FIG. 4A, FIG. 4B, FIG. 4C, FIG. 4D, and FIG. 4E illustrate steps for building a ground mounting system for solar modules, according to various aspects.

FIG. 5A illustrates a ground mounting system during construction before the small purlins are installed, according to various aspects.

FIG. 5B illustrates the ground mounting system of FIG. 5A during construction with the small purlins installed and before the solar modules are installed, according to various aspects.

FIG. 5C illustrates the ground mounting system of FIG. 5B during construction with the solar modules installed and with cleaning machines installed, according to various aspects.

FIG. 6 illustrates a stopping member installed at an end of a large purlin, according to various aspects.

FIG. 7 illustrates a stopping member installed at an end of a large purlin, according to various aspects.

FIG. 8 illustrates a safety cable system installed to a large purlin, according to various aspects.

FIG. 9 illustrates the safety cable system of FIG. 8, according to various aspects.

### DETAILED DESCRIPTION

Disclosed herein are systems, methods, and/or devices, for implementing a ground mounting system for solar modules. A mounting system for solar modules includes a first plurality of purlins (also referred to herein as large purlins) each comprising an upward facing opening providing access to a longitudinal channel of the purlin, a first row of solar panels extending along a first side of a longitudinal channel, and a second row of solar panels extending along a second side of the longitudinal channel. The first row of solar panels is spaced apart from the second row of solar panels by a gap located at the upward facing opening so as to accommodate a track or wheel of a solar module cleaning machine to be received therebetween. A tread layer can be disposed in the longitudinal channel(s) to provide a gripping surface (e.g., traction) for the track or wheel of the cleaning machine.

A mounting system for solar modules provides an easily cleanable, ground-mount, on-site solar photovoltaic racking system designed to minimize the impact on the functionality of the space below the racking system. A mounting system for solar modules allows a ground-mount solar photovoltaic array to be installed at a site without affecting the current or future use of the area below the array. The design is modular in nature, such that the structure can expand in either direction as desired. A mounting system for solar modules also allows for the modules to be accessed for cleaning practically and efficiently via the large purlin(s), as described herein in greater detail.

Solar panel arrays are used for generating power, and there is a need to install an array that tends to minimize the impact on the space below the array and does not affect the site's future use. Additionally, solar panels need to be cleaned periodically to operate optimally. The mounting system disclosed herein, in various embodiments, for solar modules provides a means to clean the solar panels efficiently.

A mounting system for solar modules includes large purlins (e.g., C-purlins, U-purlins, or the like) that are oriented with the opening of the longitudinal channel of the large purlin facing upward (e.g., in a U-shape) The solar modules are disposed in rows along each side of the large purlin with the rows spaced apart by a gap so that the longitudinal channel remains exposed from the top side of the solar modules. In this regard, a person can walk along the longitudinal channel and/or tracks or wheels of a cleaning machine can be disposed in the longitudinal channel from the top side of the solar modules. A tread layer in the longitudinal channel can provide traction for a person or a cleaning machine to move along the longitudinal channel while minimizing slipping.

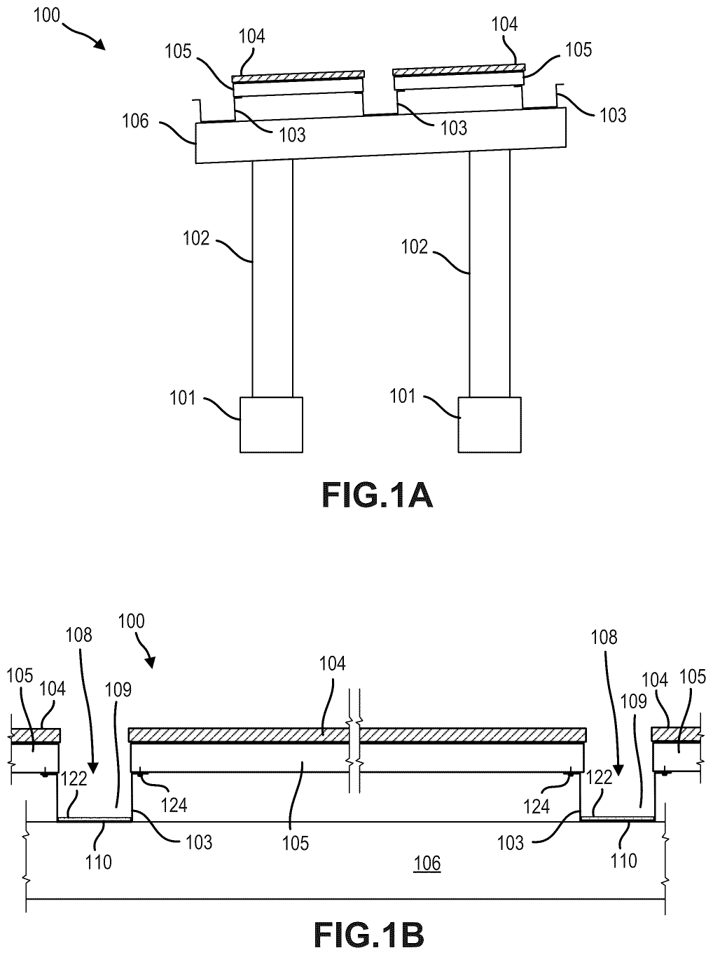

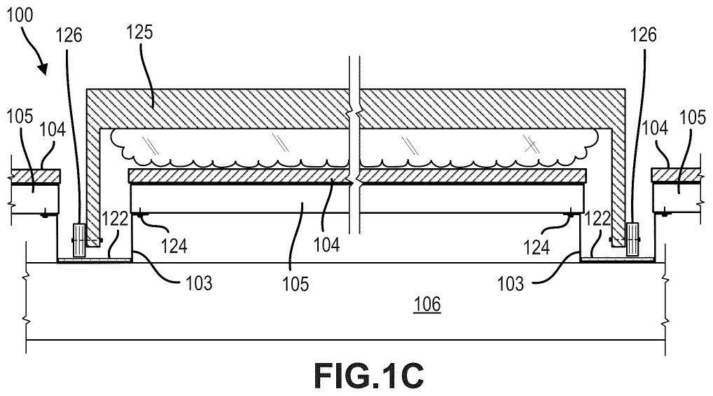

FIG. 1A is side view of a ground mounting system 100 for solar modules 104, in accordance with various aspects. The ground mounting system 100 generally comprises a foundation 101, columns 102 supported by the foundation 101, I-beam support members 106, a first plurality of purlins 103 (also referred to herein as “large purlins”), and a second plurality of purlins 105 (also referred to herein as “small purlins”). The small purlins 105 extend perpendicular to the large purlins 103. The solar modules 104 can be coupled to the small purlins 105. The ground mounting system 100 can be erected at a desired site (e.g., in situ) at an angle optimized to generate solar power. For example, the I-beam support members 106 can extend horizontally or at an angle with respect to the horizontal direction so that the solar modules 104 face a direction of the sun. In various aspects, the I-beam support members 106 may be angled by between three degrees and seven degrees, or about five degrees, with respect to the horizontal direction to provide a slope that runs along the long-axis of the I-beam support members 106. In various aspects, the large purlins 103 may be angled by between three degrees and seven degrees, or about five degrees, with respect to the horizontal direction to provide a slope that runs along the long-axis of the large purlins 103. For example, the I-beam support members 106 can be mounted at progressively increasing elevations to cause the slope or pitch along the long-axis of the large purlins 103. This slope can aid in keeping the solar modules 104 cleaner, but can be kept small in order to minimize the height difference of the structure from one side of the array to the other.

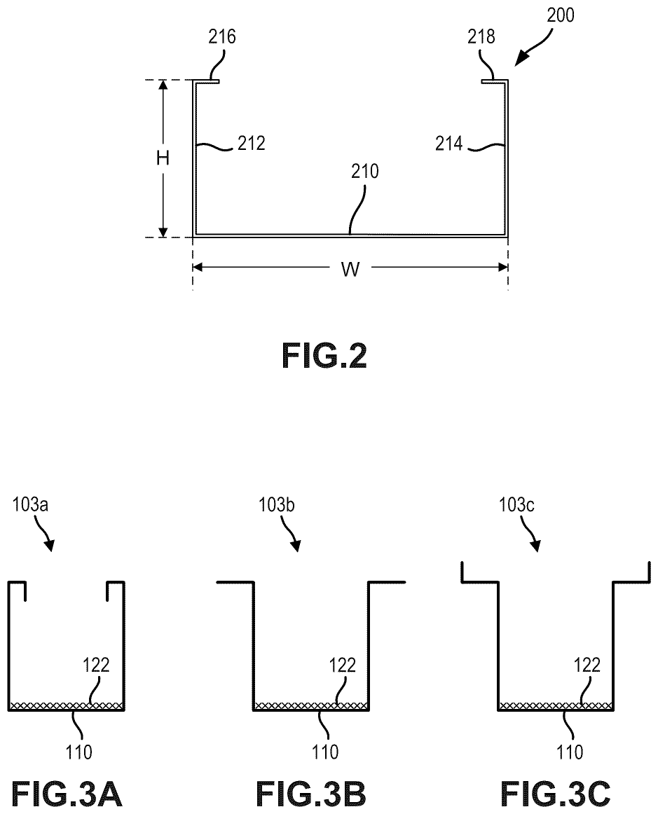

With momentary reference to FIG. 2, a section view of an example C-purlin 200 is illustrated, in accordance with various aspects. The C-purlin includes a base wall 210, opposing side walls (e.g., a first side wall 212 and a second side wall 214), and opposing flanges (e.g., a first flange 216 and a second flange 218) projecting from the side walls 212, 214, respectively, toward one another. The purlin 200 can have a width W and a height H. As used herein, the term “large purlin” refers to a purlin that is larger than a “small purlin.” Conversely, the term “small purlin” refers to a purlin that is smaller than a “large purlin.” For example, a large purlin can have a width W that is greater than that of the small purlin. In various aspects, a large purlin can have a height H that is greater than that of the small purlin. In various aspects, a large purlin has a height H and a width W that are both greater than that of the small purlin. In various aspects, a large purlin has a thickness that is greater than that of the small purlin.

In various aspects, the base wall 210 of the purlin 200 can be oriented substantially (±20°) horizontally in the installed position. In various aspects, the side walls 212, 214 of the purlin 200 can be oriented substantially (±20°) vertically in the installed position. In various aspects, the base wall 210 of the purlin 200 can be oriented parallel to the flanges 216, 218.

With reference to FIG. 1B, an enlarged view of the ground mounting system 100 is illustrated, in accordance with various aspects. The large purlins 103 can extend lengthwise over and across the plurality of I-beam support members 106. Stated differently, the large purlins 103 can be oriented perpendicular to the I-beam support members 106. The small purlins 105 can extend lengthwise over and across the large purlins 103. Stated differently, the small purlins 105 can be oriented perpendicular to the large purlins 103. A length of each of the small purlins 105 can be less than that of each of the large purlins 103. The large purlins 103 can be positioned so that the openings 108 of the large purlins 103 face upwards (i.e., toward the solar modules 104). The openings 108 can provide access to longitudinal channels 109 formed by the interior surfaces of the large purlins 103. In various aspects, a tread layer 122 can be disposed on the exposed interior surface of the base wall 110 of the large purlin 103. The tread layer 122 can provide a rough surface for a cleaning machine to ride along when cleaning the solar modules 104. The tread layer 122 can comprise a coefficient of friction that is greater than that of the large purlin 103.

In various aspects, the small purlins 105 can be coupled to the large purlins 103 via fasteners 124, such as self-tapping screws for example. The fasteners 124 can extend through the flanges of the large purlins 103 into the base walls of the small purlins 105.

FIG. 1C shows a cleaning machine 125 installed over the ground mounting system 100 for cleaning the solar modules 104. The cleaning machine 125 can include wheels and/or tracks 126 that ride along the large purlin 103. The wheels and/or tracks 126 can ride along the tread layer 122. The cleaning machine 125 is suitable for cleaning debris (e.g., dust, bird droppings, scaling, snow, and the like) on the solar modules 104. The cleaning machine 125 is arranged above the solar modules 104 in a straddling manner and is used for scraping and/or scrubbing debris on the solar modules 104 in the travelling process. The cleaning machine 125 can be driven by powered wheels and/or tracks 126 that roll along the tread layer 122 in a travelling direction along the length of the large purlins 103.

FIG. 3A through FIG. 3C show example purlins having flanges of various shapes that could be used with a ground mounting system. In FIG. 3A, the purlin 103a can include flanges that are bent toward the base wall 110. In FIG. 3B, the purlin 103b can include flanges that are bent outwards in opposite directions. In FIG. 3C, the purlin 103c can include flanges that extend outward from the side walls in opposite directions and are bent away from the base wall 110.

In various aspects, the tread layer 122 can be adhered to an interior surface of the base wall 110. In various aspects, the tread layer 122 can be sprayed onto the base wall 110. In various aspects, the tread layer 122 can be brushed, rolled, or spread onto the base wall 110. The tread layer 122 can comprise a rubber, plastic, or composite material. The tread layer 122 can comprise a textured epoxy resin. The tread layer 122 can comprise a textured epoxy resin comprising a grit (e.g., silica, silicon dioxide, metal, etc.) additive. In various aspects, the tread layer 122 can comprise a layer thickness of between 1/32 inch and ¼ inch (0.079375 cm-0.635 cm), a layer thickness of between 1/32 inch and ⅛ inch (0.079375 cm-0.3175 cm), or a layer thickness of between 1/32 inch and 1/16 inch (0.079375 cm-0.15875 cm).

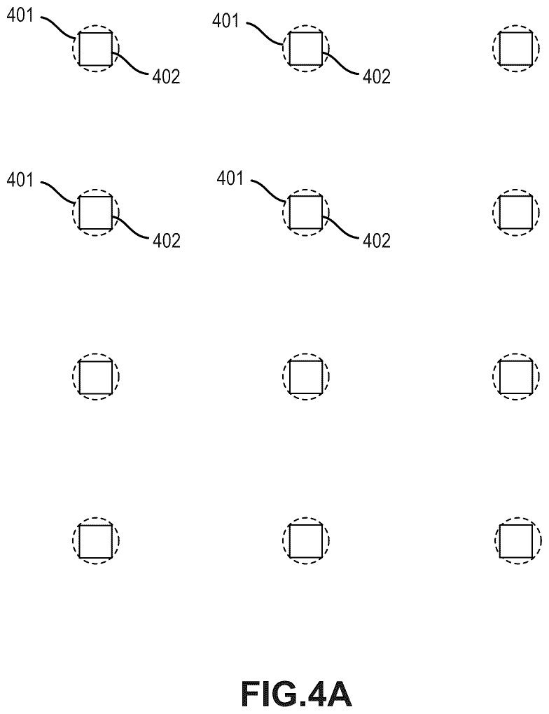

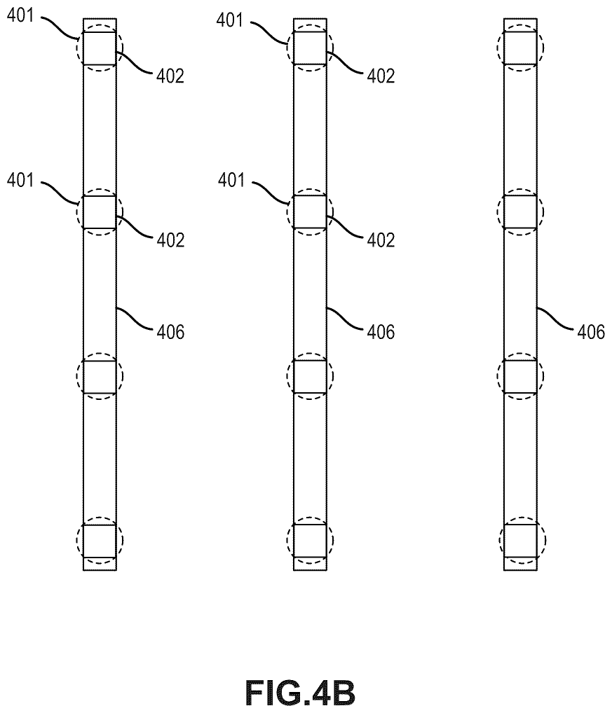

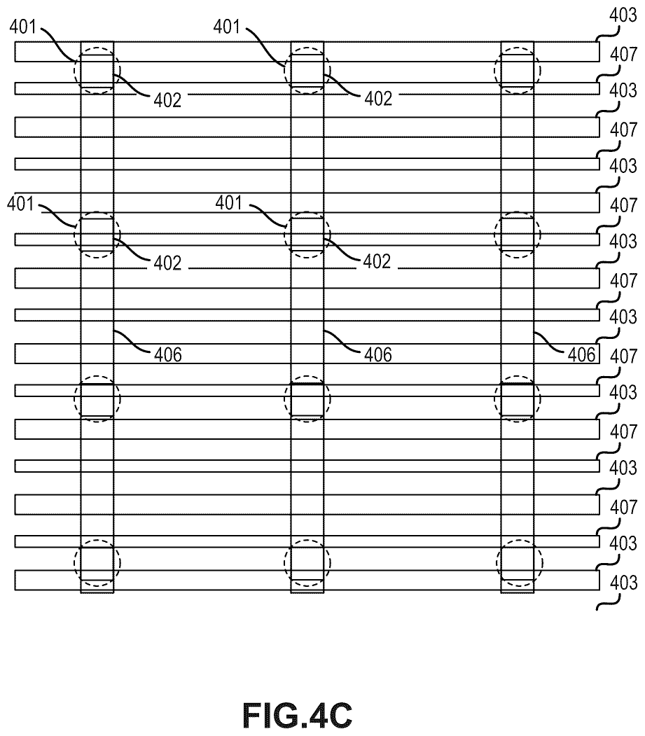

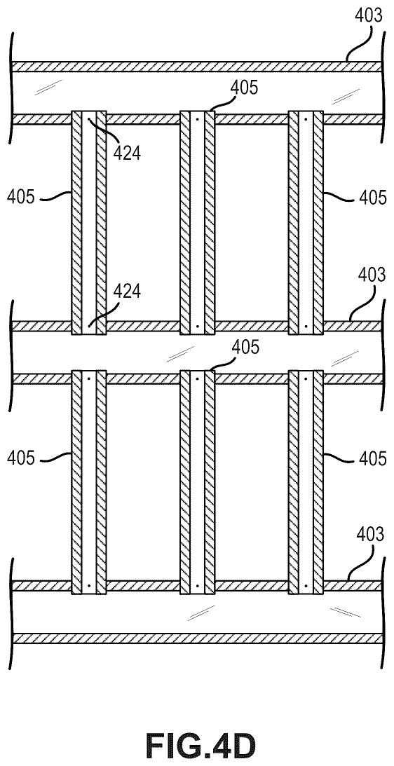

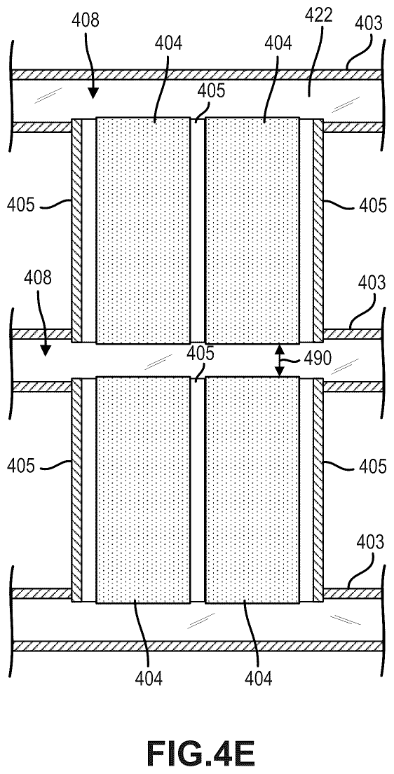

With reference to FIG. 4A through FIG. 4E a method for building/installing a ground mounting system 400 is illustrated, in accordance with various aspects. The ground mounting system 400 can be similar to the ground mounting system 100 described with respect to FIG. 1A through FIG. 3C, in accordance with various aspects. In FIG. 4A, the foundations 401 are dug and constructed and the upright columns 402 are mounted in place. FIG. 4A is a top view or a plan view showing 4 rows with 3 posts per row. However, any number of rows and posts per row can be used as desired, depending on the desired size of the structure.

In FIG. 4B, the I-beam support members 406 are mounted on top of the upright columns 402. The I-beam support members 406 can be removably coupled to the upright columns 402 using fasteners. The I-beam support members 406 can be coupled to the upright columns 402 using a metal joining process (e.g., welding, soldering, or brazing).

In FIG. 4C, the large purlins 403 are installed on top of, and perpendicular to, the I-beam support members 406. Smaller support members 407 (e.g., small I-beam, c-purlin, or z-purlin) can be mounted parallel to, and in between, the large purlins 403. The smaller support members 407 are also attached to the I-beam support members 406.

In FIG. 4D, the small purlins 405 that support the solar modules can be mounted perpendicular to, and in between, the large purlins 403. The small purlins 405 can be attached to the large purlins 403 via fasteners 424, such as self-tapping screws. A length of each of the small purlins 405 can be less than a length of each of the large purlins 403.

In FIG. 4E, the solar modules 404 are placed on top of the small purlins 405. The solar modules 404 can be attached to the small purlins 405 via a plurality of fasteners (e.g., bolts and nuts). The solar modules 404 can be attached to the flanges of the respective small purlins 405 via a plurality of fasteners. In this regard, the small purlins 405 can be oriented with upward facing openings, similar to the large purlins 403. The solar modules 404 can comprise a rectangular geometry. The solar modules 404 can be oriented parallel to the small purlins 405 (i.e., the major axis of the solar modules 404 is parallel to the small purlins 405). The solar modules 404 can be oriented perpendicular to the large purlins 403. In various aspects, each small purlin 405 is attached to two different solar modules 404 (e.g., with one solar module 404 attached to each flange of the small purlin 405), except that the small purlins 405 located at the outer edges of the structure can be mounted to only one solar module 404.

In various aspects, the ends of the small purlins 405 extend slightly (e.g., between ⅛ inch and one inch) over the opening 408 of the large purlin 403. In various aspects, the ends of the solar modules 404 extend slightly (e.g., between ⅛ inch and one inch) over the ends of the small purlins 405. In various aspects, the ends of the solar modules 404 extend slightly (e.g., between ⅛ inch and two inches) over the opening 408 of the large purlin 403. In various aspects, the ends of the solar modules 404 extend slightly past the ends of the small purlins 405 so as to leave sufficient space for the cleaning machine to ride along the openings 408 of the large purlins 403. For example, the solar modules 404 can be spaced apart on opposite sides of the opening 408 by a gap or a dimension 490. The gap 490 can be located at the opening 408 of the large purlin 403 so as to accommodate a foot of a person or a wheel or track of a cleaning machine to be placed into the opening 408. The dimension 490 is measured along the lengthwise direction of the small purlins 405. The dimension 490 can be between at least 5 inches (12/7 cm). The dimension 490 can be between 5 inches and 12 inches (12.7 cm-30.48 cm). In this regard, the large purlins 403 can provide not only a track for a cleaning machine to travel, but also a pathway for a person to walk for cleaning, installing, and/or maintaining the solar modules 404.

In various embodiments, the solar modules 404 are disposed along the track formed by the large purlin 403. Stated differently, the solar modules 404 can be disposed along the tread layer 422 formed on the bottom surfaces of the openings 408 of the large purlins 403.

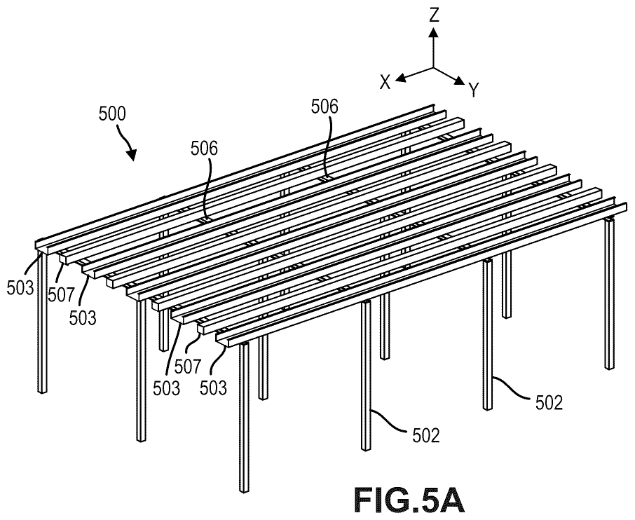

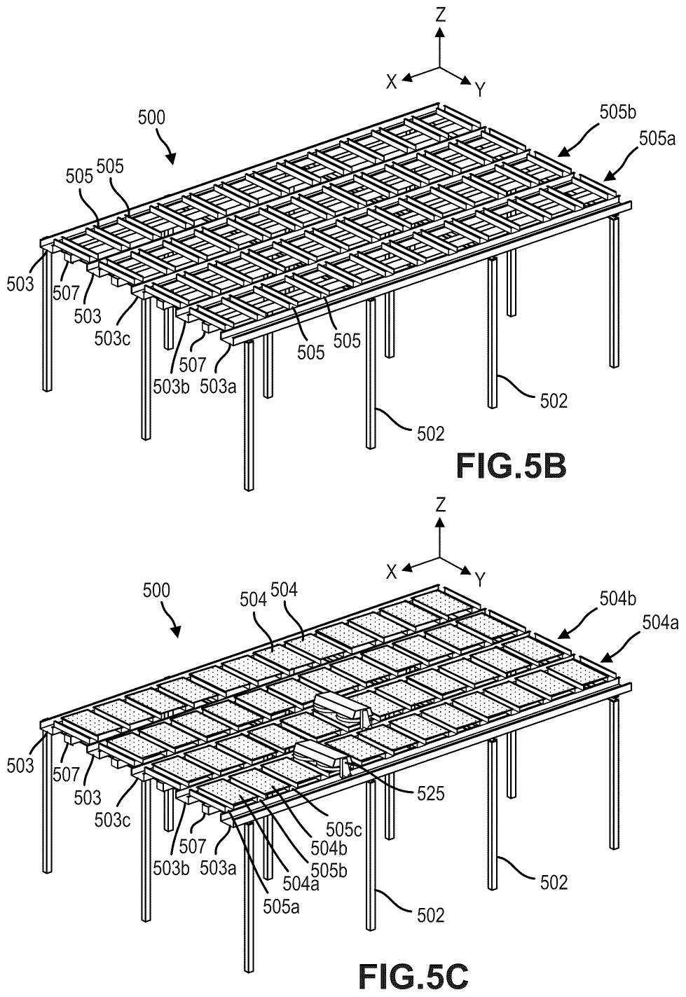

FIG. 5A shows a ground mounting system 500 before the small purlins and the solar modules are installed, in accordance with various aspects. In various aspects, the ground mounting system 500 can be similar to the ground mounting system described with respect to FIG. 4A through FIG. 4E. The ground mounting system 500 generally includes the upright columns 502, the I-beam support members 506, and the large purlins 503. Smaller support members 507 (e.g., small I-beam, c-purlin, or z-purlin) can be mounted parallel to, and in between, the large purlins 503. The smaller support members 507 can be attached to the I-beam support members 506. The I-beam support members 506 can extend across the tops of the upright columns 502. In the illustrated example, there are four I-beam support members 506, each extending across three upright columns 502.

The large purlins 503 can extend across the I-beam support members 506 in a longitudinal direction (i.e., the X-direction). The large purlins 503 can be oriented perpendicular to the I-beam support members 506.

FIG. 5B shows the ground mounting system 500 with the small purlins 505 installed, in accordance with various aspects. The small purlins 505 can extend crosswise or transverse with respect to the large purlins 503 (i.e., the Y-direction). The small purlins 505 can be oriented perpendicular to the large purlins 503. A first row of small purlins 505a can extend between and to a first large purlin 503a and a second large purlin 503b. A second row of small purlins 505b can extend between and to the second large purlin 503b and a third large purlin 503c. Additional rows of small purlins 505 can extend between and to the third large purlin 503c and a fourth large purlin 503, and the fourth large purlin and a fifth large purlin, and so on and so forth, depending on the desired size of the ground mounting system 500. In the illustrated example, there are four rows of small purlins 505 and five large purlins 503. In the illustrated example, there are thirteen small purlins 505 in the first row of small purlins 505a and thirteen small purlins 505 in the second row of small purlins 505b.

FIG. 5C shows the ground mounting system 500 with the solar modules 504 mounted/installed to the small purlins 505, in accordance with various aspects. The solar modules 504 can be rectangular in shape with their longitudinal axes oriented parallel (i.e., along the Y-direction) to the small purlins 505. The solar modules 504 can extend crosswise or transverse (i.e., along the Y-direction) with respect to the large purlins 503. The solar modules 504 can be oriented perpendicular to the large purlins 503. A first solar module 504a can extend between and to a first small purlin 505a and a second small purlin 505b. A second solar module 504b can extend between and to the second small purlin 505b and a third small purlin 505c. Additional solar modules 504 can extend between and to the third small purlin 505c and a fourth small purlin 505, and the fourth small purlin and a fifth small purlin, and so on and so forth, depending on the desired size of the ground mounting system 500.

The first solar module 504a, the second solar module 504b, and the third solar module 504c can be part of a first row of solar modules 504a. In the illustrated example, there are twelve solar modules 504 in the first row of solar modules 504a. The first row of solar modules 504a can be located between the first large purlin 503a and the second large purlin 503b. A second row of solar modules 504b can be located between the second large purlin 503b and the third large purlin 503c. In the illustrated example, there are twelve solar modules 504 in the second row of solar modules 504b. The first row of solar modules 504a is spaced apart from the second row of solar modules 504b (e.g., see the gap 490 of FIG. 4E) to provide clearance for a cleaning machine 525 to travel along the second large purlin 503b. The cleaning machine 525 can be arranged above the first row of solar modules 504a in a straddling manner with the wheels/tracks of the cleaning machine 525 configured to travel along the first large purlin 503a and the second large purlin 503b. The cleaning machine 525 can travel along a travelling direction (i.e., along the X-direction) for scraping and/or scrubbing debris on the solar modules 504 in the travelling process. Similarly, a cleaning machine 525 can be arranged above the second row of solar modules 504b in a straddling manner with the wheels/tracks of the cleaning machine 525 configured to travel along the second large purlin 503b and the third large purlin 503c for cleaning the second row of solar modules 504b. In this regard, the large purlins 503 both support the small purlins 505 and the solar modules 504 and also provide a track for the cleaning machine 525 to travel. Additionally, the large purlins 503 provide a walkway for a user to walk when maintaining and/or installing the solar modules 504.

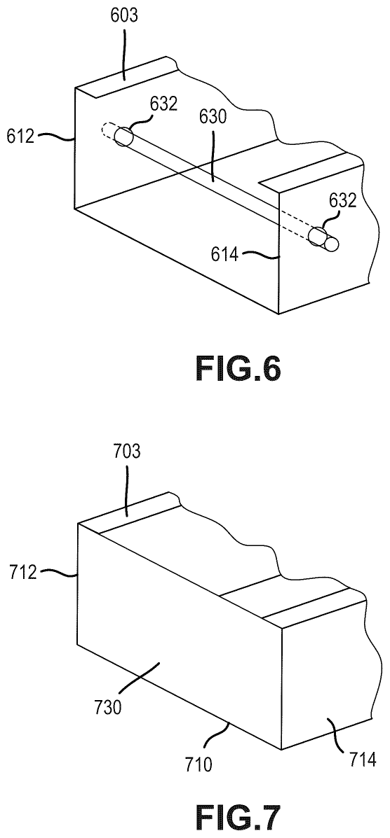

FIG. 6 shows a large purlin 603 with a stopping member 630 installed at an end of the large purlin 603, in accordance with various aspects. The stopping member 630 can stop the cleaning machine from running off of the large purlin 603. Stated differently, the stopping member 630 can provide a stopping surface for the cleaning machine to contact before running off of the large purlin 603. The stopping member 630 can be a rod, a pin, or a fastener extending through the side walls 612, 614 of the large purlin 603. In this regard, apertures 632 can be disposed in the side walls 612, 614. The apertures 632 can be aligned (e.g., coaxial) so that the stopping member 630 can be disposed in the apertures 632 in the installed position.

FIG. 7 shows a large purlin 703 with a stopping member 730 installed at an end of the large purlin 703, in accordance with various aspects. The stopping member 730 can stop the cleaning machine from running off of the large purlin 703. Stated differently, the stopping member 730 can provide a stopping surface for the cleaning machine to contact before running off of the large purlin 703. The stopping member 730 can be a plate extending from at least one of the base wall 710, the first side wall 712, or the second side wall 714. In various aspects, the stopping member 730 can extend between and to the first side wall 712 and the second side wall 714. In various aspects, the stopping member 730 can extend from the base wall 710. The stopping member 730 can be removably coupled to the large purlin 703 via one or more fasteners (e.g., self-tapping screws). The stopping member 730 can be monolithic with the large purlin 703.

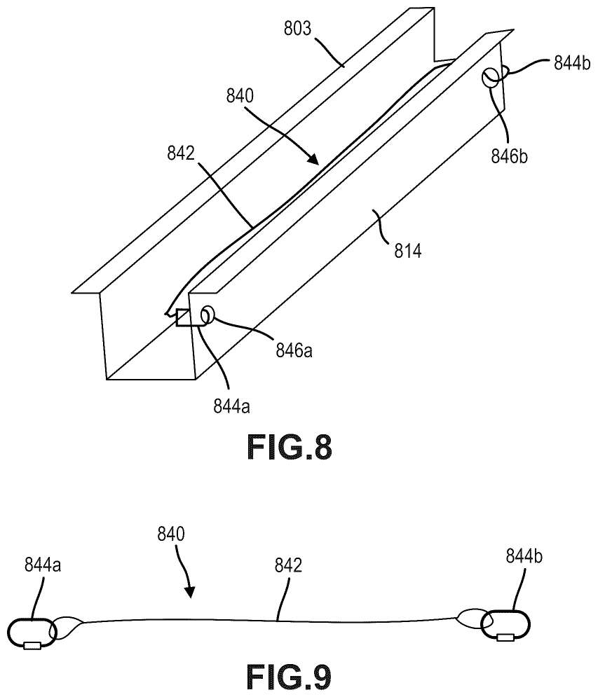

FIG. 8 and FIG. 9 show a safety cable system 840 for a large purlin 803. The safety cable system 840 can be used for fall protection for a person walking along the large purlin 803. The safety cable system 840 can include a cable 842 with couplers 844a and 844b disposed at opposing ends of the cable 842. The couplers 844a and 844b can be carabiners or the like. The cable 842 can be a braided cable, a coated cable, or any other suitable flexible cable or rope. The couplers 844a and 844b can be coupled to opposing ends of the large purlin 803, for example at apertures 846a and 846b disposed in a side wall 814 of the large purlin 803. A user can clip onto the safety cable 842 via a user-wearable harness system for securing the person to the safety cable system 840. The cable 842 spans the length of the large purlin 803 so that the person can walk freely along the length of the large purlin 803 while remaining clipped into the safety cable system 840.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “various aspects,” “one aspect,” “an aspect,” “an example aspect,” “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is intended to invoke 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A mounting system for solar modules, comprising:
a plurality of upright columns;
a first plurality of purlins supported by the plurality of upright columns, each purlin of the first plurality of purlins comprises an upward facing opening providing access to a longitudinal channel; and
a second plurality of purlins extending over and perpendicular to the first plurality of purlins.

2. The mounting system of claim 1, further comprising a tread layer disposed in each longitudinal channel of the first plurality of purlins.

3. The mounting system of claim 2, wherein each longitudinal channel is configured to receive a wheel or track of a cleaning machine, and the tread layer provides a surface along which the wheel or track of the cleaning machine is configured to travel.

4. The mounting system of claim 3, further comprising a plurality of solar modules coupled to and supported by the second plurality of purlins.

5. The mounting system of claim 4, wherein the plurality of solar modules includes:
a first row of solar modules coupled along a first row of the second plurality of purlins; and
a second row of solar modules coupled along a second row of the second plurality of purlins, the first row of solar modules is spaced apart from the second row of solar modules by a gap; and
a first purlin of the first plurality of purlins is disposed between the first row of solar modules and the second row of solar modules, the first purlin comprises a first upward facing opening exposing a first longitudinal channel that is accessible via the gap.

6. The mounting system of claim 5, wherein the first row of solar modules comprises:
a first solar module extending between and to the first purlin of the second plurality of purlins and a second purlin of the second plurality of purlins; and
a second solar module extending between and to the second purlin of the second plurality of purlins and a third purlin of the second plurality of purlins.

7. The mounting system of claim 6, further comprising a plurality of I-beam support members supported by the plurality of upright columns, wherein the first plurality of purlins extend over and across the plurality of I-beam support members.

8. The mounting system of claim 7, wherein the gap is at least five inches.

9. The mounting system of claim 7, wherein each purlin of the first plurality of purlins is a large purlin and each purlin of the second plurality of purlins is a small purlin.

10. A mounting system for solar modules, comprising:
a first large purlin extending lengthwise along a first direction, the first large purlin comprises a first upward facing opening exposing a first longitudinal channel, the first longitudinal channel is configured to receive a first wheel or track of a cleaning machine;
a second large purlin extending lengthwise along the first direction, parallel to the first large purlin, the second large purlin comprises a second upward facing opening exposing a second longitudinal channel, the second longitudinal channel is configured to receive a second wheel or track of the cleaning machine;
a third large purlin extending lengthwise along the first direction, parallel to the first large purlin, the third large purlin comprises a third upward facing opening exposing a third longitudinal channel;
a first small purlin extending lengthwise along a second direction perpendicular to the first direction, the first small purlin coupled between and to the first large purlin and the second large purlin;
a second small purlin extending lengthwise along the second direction perpendicular to the first direction, the second small purlin coupled between and to the first large purlin and the second large purlin;
a third small purlin extending lengthwise along the second direction perpendicular to the first direction, the third small purlin coupled between and to the first large purlin and the second large purlin;
a first solar module extending between and to the first small purlin and the second small purlin; and
a second solar module extending between and to the second small purlin and the third small purlin.

11. The mounting system of claim 10, further comprising:
a fourth small purlin extending lengthwise along the second direction perpendicular to the first direction, the fourth small purlin coupled between and to the second large purlin and the third large purlin;
a fifth small purlin extending lengthwise along the second direction perpendicular to the first direction, the fifth small purlin coupled between and to the second large purlin and the third large purlin;
a sixth small purlin extending lengthwise along the second direction perpendicular to the first direction, the sixth small purlin coupled between and to the second large purlin and the third large purlin;
a third solar module extending between and to the fourth small purlin and the fifth small purlin; and
a fourth solar module extending between and to the fifth small purlin and the sixth small purlin;
wherein the first solar module and the second solar module are on a first side of the second large purlin and the third solar module and the fourth solar module are on a second side of the second large purlin, opposite the first side, and the first solar module and the second solar module are separated from the third solar module and the fourth solar module by a gap located at the second upward facing opening of the second large purlin.

12. The mounting system of claim 11, further comprising a tread layer disposed in at least one of the first longitudinal channel, the second longitudinal channel, or the third longitudinal channel.

13. The mounting system of claim 12, wherein the tread layer comprises a textured epoxy resin.

14. The mounting system of claim 12, further comprising:
a plurality of upright columns; and
a plurality of I-beam support members supported by the plurality of upright columns, wherein the first large purlin, the second large purlin, and the third large purlin extend over and across the plurality of I-beam support members.

15. The mounting system of claim 12, wherein at least one of the first large purlin, the second large purlin, or the third large purlin comprises a stopping member coupled to an end of the at least one of the first large purlin, the second large purlin, or the third large purlin.

16. The mounting system of claim 12, wherein at least one of the first large purlin, the second large purlin, or the third large purlin comprises a safety cable system extending along a length of the at least one of the first large purlin, the second large purlin, or the third large purlin, wherein the at least one of the first large purlin, the second large purlin, or the third large purlin comprises a first aperture and a second aperture and the safety cable system is coupled to the at least one of the first large purlin, the second large purlin, or the third large purlin via the first aperture and the second aperture.

17. A method for manufacturing a mounting system for solar modules, the method comprising:
disposing a first large purlin to extend lengthwise along a first direction, the first large purlin comprises a first upward facing opening exposing a first longitudinal channel, the first longitudinal channel is configured to receive a first wheel or track of a cleaning machine;
disposing a second large purlin to extend lengthwise along the first direction, parallel to the first large purlin, the second large purlin comprises a second upward facing opening exposing a second longitudinal channel, the second longitudinal channel is configured to receive a second wheel or track of the cleaning machine;
disposing a third large purlin to extend lengthwise along the first direction, parallel to the first large purlin, the third large purlin comprises a third upward facing opening exposing a third longitudinal channel;
disposing a first small purlin to extend lengthwise along a second direction perpendicular to the first direction, the first small purlin coupled between and to the first large purlin and the second large purlin;
disposing a second small purlin to extend lengthwise along the second direction perpendicular to the first direction, the second small purlin coupled between and to the first large purlin and the second large purlin;
disposing a third small purlin to extend lengthwise along the second direction perpendicular to the first direction, the third small purlin coupled between and to the first large purlin and the second large purlin;
disposing a first solar module to extend between and to the first small purlin and the second small purlin; and
disposing a second solar module to extend between and to the second small purlin and the third small purlin.

18. The method of claim 17, further comprising:
disposing a fourth small purlin to extend lengthwise along the second direction perpendicular to the first direction, the fourth small purlin coupled between and to the second large purlin and the third large purlin;
disposing a fifth small purlin to extend lengthwise along the second direction perpendicular to the first direction, the fifth small purlin coupled between and to the second large purlin and the third large purlin;
disposing a sixth small purlin to extend lengthwise along the second direction perpendicular to the first direction, the sixth small purlin coupled between and to the second large purlin and the third large purlin;
disposing a third solar module to extend between and to the fourth small purlin and the fifth small purlin; and
disposing a fourth solar module to extend between and to the fifth small purlin and the sixth small purlin;
wherein the first solar module and the second solar module are on a first side of the second large purlin and the third solar module and the fourth solar module are on a second side of the second large purlin, opposite the first side, and the first solar module and the second solar module are separated from the third solar module and the fourth solar module by a gap located at the second upward facing opening of the second large purlin.

19. The method of claim 18, further comprising disposing a tread layer in at least one of the first longitudinal channel, the second longitudinal channel, or the third longitudinal channel.

20. The method of claim 19, further comprising disposing a solar module cleaning machine to straddle the first solar module with the first wheel or track of the solar module cleaning machine extending into the first longitudinal channel and the second wheel or track of the solar module cleaning machine extending into the second longitudinal channel, and the first wheel or track of the solar module cleaning machine is supported by the tread layer.
